(19) United States
(12) Patent Application Publication
(10) Pub. No.: US 2025/0262994 A1
(43) Pub. Date: Aug. 21, 2025

(54) CHILD SAFETY SEAT

(71) Applicant: WONDERLAND SWITZERLAND AG, Steinhausen (CH)

(72) Inventor: Zhiren ZHONG, Dongguan (CN)

(21) Appl. No.: 19/056,971

(22) Filed: Feb. 19, 2025

Related U.S. Application Data
(60) Provisional application No. 63/555,368, filed on Feb. 19, 2024.

(30) Foreign Application Priority Data
Apr. 1, 2024 (CN) 202410393120.6

(51) Int. Cl. B60N 2/28

(52) U.S. Cl. CPC B60N 2/2875; B60N 2/2827

(57) ABSTRACT

The present disclosure relates to a child safety seat, for being fixed to a vehicle seat, including: a base for being fixed to the vehicle seat; a seat body for seating a child and pivotally connected to the base about a pivot axis, wherein a seating gravity point of the seat body together with the child is located below the pivot axis when the child is seated in the seat body; and a buffer structure disposed between the base and the seat body, for buffering a pivotal movement of the seat body relative to the base.

### CROSS-REFERENCE TO RELATED APPLICATIONS

This application claims priority to U.S. Provisional Application No. 63/555,368, entitled “Child Restrain System” and filed on Feb. 19, 2024, and Chinese Application No. 202410393120.6, entitled “CHILD SAFETY SEAT” and filed on Apr. 1, 2024, all of which are incorporated herein by reference in its entirety.

### TECHNICAL FIELD

The present disclosure relates to a child safety seat, particularly a buffered child safety seat, which may be fixed to a seat of a transport vehicle, in particular a car.

### BACKGROUND

At present, fixation methods for car safety seats are complex. Standardized fixation systems, such as ISOFIX, require additional load legs, top tethers, or low tethers, aiming to address an issue of head displacement.

### SUMMARY

The present disclosure provides a child safety seat, for being fixed to a vehicle seat, including: a base for being fixed to the vehicle seat; a seat body for seating a child and pivotally connected to the base about a pivot axis, wherein a seating gravity point of the seat body together with the child is located below the pivot axis when the child is seated in the seat body; and a buffer structure disposed between the base and the seat body, for buffering a pivotal movement of the seat body relative to the base.

In an embodiment, the child safety seat includes a position locking structure disposed between the seat body and the base, for locking the seat body at various angles relative to the base.

In an embodiment, the base includes a base body for being fixed to the vehicle seat and side portions extending upward from both sides of the base body, wherein pivot connection portions are respectively provided on the side portions, and the seat body is disposed in a receiving space formed between the base body and the side portions, the seat body having a pivot portion cooperating with the pivot connection portions, wherein centers of the pivot connection portions and the pivot portion form the pivot axis to enable the pivotal movement of the seat body relative to the base.

In an embodiment, the seat body has side wings for lateral protection of the child, and the pivot portion is provided on the side wings.

In an embodiment, the pivot connection portion is configured to be hollow.

In an embodiment, the position locking structure is disposed between the base body of the base and a seat portion of the seat body, the position locking structure including: a positioning portion located on the base body; a locking portion located on the seat portion and movable relative to the positioning portion, wherein the positioning portion is configured to: in a normal use state, adjustably lock an angle of the seat body by positioning the locking portion; and in a collision state, release the locking portion to allow the seat body to pivot, such that an angle of the seat body in the collision state is greater than an angle of the seat body before the collision state, so as to achieve the pivotal adjustment of the seat body to a relatively upright angle.

In an embodiment, the buffer structure is a compression spring, the seat body has an abutment portion for abutting one end of the compression spring, the abutment portion being integrally formed with the locking portion, and the other end of the compression spring is fixed to a fixation portion provided on the base.

In an embodiment, the buffer structure is a tension spring, the seat body has a pulling portion for pulling one end of the tension spring, the pulling portion being integrally formed with the locking portion, and the other end of the tension spring is fixed to a fixation portion provided on the base.

In an embodiment, the position locking structure is disposed between the pivot connection portion of the base and the pivot portion of the seat body, the position locking structure including: a positioning portion located on the pivot connection portion; a locking portion located on the pivot portion and movable relative to the positioning portion, wherein the positioning portion is configured to: in a normal use state, adjustably lock an angle of the seat body by positioning the locking portion; and in a collision state, release the locking portion to allow the seat body to pivot, such that an angle of the seat body in the collision state is greater than an angle of the seat body before the collision state, so as to achieve the pivotal adjustment of the seat body to a relatively upright angle.

In an embodiment, the positioning portion and the locking portion are configured as corresponding wave portions, tooth portions, or snap portions for engaging with each other, wherein in the event of a collision, the positioning portion and the locking portion are disengaged.

In an embodiment, in a normal use state, an angle between the seat body and a horizontal plane is smaller than an angle in a collision state.

In an embodiment, in the collision state, the angle between the seat body and the horizontal plane is 50 degrees to 90 degrees.

In an embodiment, the base has, on a side facing a backrest of the vehicle seat: a retractable standardized fixation system for fixing the child safety seat to the vehicle seat; and a support member for adjusting a distance between the base and the backrest.

In an embodiment, the base has, on a side away from the backrest of the vehicle seat: a support leg that may be pivotally folded to a lower side of the base when the child safety seat is not fixed to the vehicle seat, and that supports the child safety seat when the child safety seat is fixed to the vehicle seat.

In an embodiment, the base is provided with lateral protection devices that can bounce up on both sides thereof.

### BRIEF DESCRIPTION OF THE DRAWINGS

FIG. 1 is a side view of a child safety seat according to a first embodiment of the present disclosure in a normal use state;

FIG. 2 is a side view of the child safety seat according to the first embodiment of the present disclosure in a collision state;

FIG. 3 is an exploded side view of the child safety seat according to the first embodiment of the present disclosure;

FIG. 4 is a side view of a base of the child safety seat according to the first embodiment of the present disclosure;

FIG. 5 is a side view of the child safety seat according to the first embodiment of the present disclosure;

FIG. 6 is a side view of a buffer structure according to another embodiment of the present disclosure;

FIG. 7 is a side view of a child safety seat according to a second embodiment of the present disclosure in a normal use state;

FIG. 8 is a side view of the child safety seat according to the second embodiment of the present disclosure in a collision state.

### REFERENCE NUMBERS ARE LISTED AS FOLLOWS

10 child safety seat
100 seat body
   110 seat portion
      111 upper side
      112 lower side
120 backrest
130 headrest
140 side wing
150 pivot portion
160 abutment portion
160A pulling portion
170 seating gravity point
200 base
   210 base body
      211 upper side
      212 lower side
220 support member
230 standardized fixation system (ISOFIX)
240 side portion
   241 pivot connection portion
250 lateral protection device
   260 fixation portion
   260A fixation portion
300 buffer structure, compression spring
300A buffer structure, tension spring
400A, 400B position locking structure
   410A, 410B positioning portion
   420A, 420B locking portion
500 support leg
20 vehicle seat
   21 backrest
   22 seat portion
   23 standardized fixation system interface
G gravity
F inertial force
L1, L2, L3 distance
I pivot axis
R travelling direction
V vertical direction
H horizontal plane
θ angle

### DETAILED DESCRIPTION

Although the present disclosure has been illustrated and described with reference to specific embodiments, the present disclosure should not be limited to the details shown. Rather, various modifications may be made to these details within a scope of the equivalent claims without departing from ta spirit of the present disclosure.

Directional descriptions such as “front”, “rear”, “upper” and “lower” mentioned in the present disclosure are for ease of understanding only. The present disclosure is not limited to these directions and may be adjusted according to actual circumstances. Although the present disclosure has been described with reference to exemplary embodiments, the terms used are explanatory and exemplary, rather than restrictive.

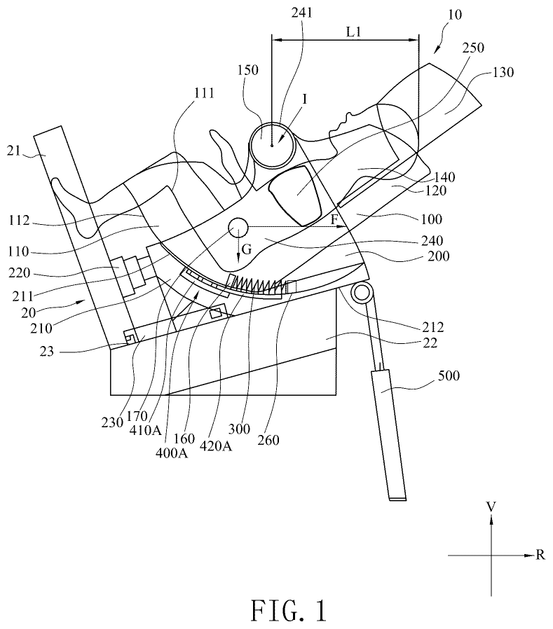

FIG. 1 is a side view of a child safety seat 10 according to a first embodiment of the present disclosure in a normal use state. According to the present disclosure, the child safety seat 10 is detachably fixed to a vehicle seat 20 of a vehicle, such as a car, during use. For example, a standardized fixation system 230 of the child safety seat 10, such as ISOFIX, is inserted into a standardized fixation system interface 23 provided between a backrest 21 and a seat portion 22 of the vehicle seat 20 to secure the child safety seat 10.

According to the present disclosure, the child safety seat 10 includes a seat body 100 and a base 200. The seat body 100 is configured to seat a child. After the child is seated in the seat body 100, the child faces the backrest 21 of the vehicle seat 20, that is, the child sits in the seat body 100 facing rearward, opposite to a traveling direction R of the vehicle.

According to the present disclosure, the seat body 100 includes a seat portion 110, a headrest 130, and two side wings 140. The seat portion 110 is configured to seat the child. A backrest 120 is configured to support the child's back. The headrest 130 is configured to support the child's head, and the headrest 130 may be adjusted relative to the backrest 120 to accommodate children of different heights. The two side wings 140 are configured to protect the child from both sides. The side wings 140 may be integrally formed with the seat portion 110 and the backrest 120 to provide better structural strength. According to the present disclosure, the seat portion 110 has an upper side 111 and a lower side 112, where the child sits on the upper side 111, and the lower side 112 is designed to be at least partially arc-shaped.

According to the present disclosure, the base 200 includes a base body 210, a support member 220, a standardized fixation system 230, and two side portions 240. The base body 210 is placed on the seat portion 22 of the vehicle seat 20. The support member 220 is movably (e.g., telescopically or pivotally) supported between the base body 210 and the backrest 21 of the vehicle seat 20 in an unlocked state, for adjusting space for legs of children of different ages, and is fixedly supported between the base body 210 and the backrest 21 of the vehicle seat 20 in a locked state to provide additional support force to the child safety seat 10. The standardized fixation system 230 may extend to be inserted into the standardized fixation system interface 23 of the vehicle seat 20 and retracted into the base body 210 when the child safety seat 10 is separated from the vehicle seat 20. The two side portions 240 extend respectively upward in the vertical direction V from the base body 210 along both sides in the traveling direction R and may be designed to be integrally formed with the base body 210 according to the present disclosure, for example. Additionally, lateral protection devices 250 may be provided on the two side portions 240. The lateral protection devices 250 are folded against the side portions 240 in a folded state and protrude from the side portions 240 along both sides in the traveling direction R in an unfolded state to provide additional lateral protection for the child. The base body 210 has an upper side 211 and a lower side 212. The base body 210 is placed on the seat portion 22 of the vehicle seat 20 in sake of the flat lower side 212, and the upper side 211 of the base body 210 is designed to be arc-shaped corresponding to the lower side 112 of the seat portion 110 of the seat body 100. According to this embodiment, a foldable support leg 500 is also provided on the front side of the lower side 212 of the base body 210 along the traveling direction R. The support leg 500, in the unfolded state shown in FIG. 1, is supported at its lower end on, for example, a floor of the car to provide additional support force.

According to the present disclosure, the two side portions 240 are respectively provided with pivot connection portions 241 at their upper sides. The pivot connection portions 241 cooperate with pivot portions 150 provided on the two side wings 140 of the seat body 100 (obscured by the pivot connection portions 241 in FIG. 1) to enable the seat body 100 to pivot relative to the base 200. The pivot connection portions 241 and the pivot portions 150 together form a pivot connection point between the seat body 100 and the base 200 and constitute a rotation center where the seat body 100 is rotatable relative to the base 200. The rotation center has a pivot axis I. For example, the pivot connection portions 241 may be designed as hollow rings, and the pivot portions 150 may be shape-fitted into the hollow rings to slide or rotate within the hollow rings, for example, with the aid of balls. The hollow pivot connection portions 241 additionally provide, for example, a handle position, making it convenient for a user to use them as handles when moving the base 200. The structure and cooperation of the pivot connection portions 241 and the pivot portions 150 may be designed in any manners, as long as they enable the connection between the seat body 100 and the base 200 and allow the seat body 100 to pivot relative to the base 200. The present disclosure is not limited thereto.

According to the present disclosure, the seat body 100 may be detached from the base 200, for example, to carry or store the seat body 100 and the base 200 separately. During normal use while the vehicle is in motion, the pivot portions 150 of the seat body 100 are detachably connected to the pivot connection portions 241 of the base 200, so that the seat body 100 may pivot relative to the base 200 when being assembled on the base 200.

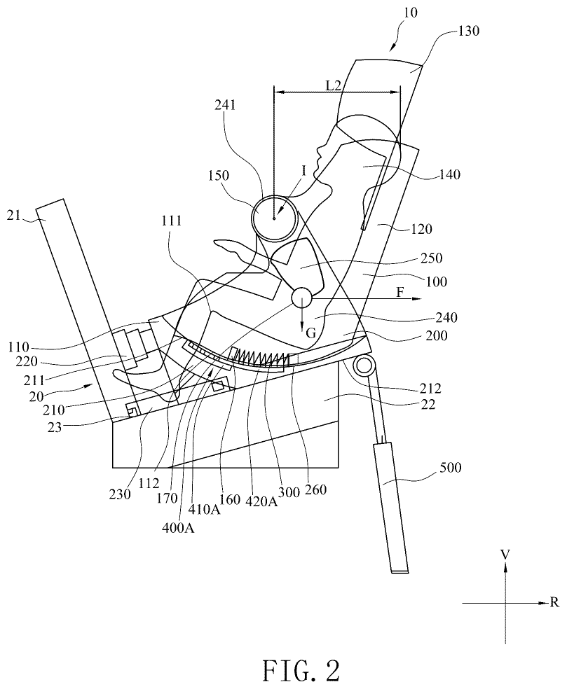

As can be seen from FIG. 1, in the normal use state, the child is in a semi-reclined position after sitting in the seat body 100. Since the child's body is in close contact with the seat body 100 in this case, the child and the seat body 100 may be regarded as forming a single entity. A seating gravity point 170 of the child corresponds to an action point of the gravity G of the seat body 100 together with the child. The seating gravity point 170 is located below the pivot axis I when viewed along a vertical direction V. At this time, the child's seating posture is relatively comfortable due to the semi-reclined state, which is conducive to the child's rest and sleep during the ride and does not compress the child's spine for a long time. Along the traveling direction R, a distance L1 between a frontmost part of the child's head and the pivot axis I is relatively long. When the vehicle is subjected to a collision, the base 200 remains stationary due to its fixed connection with the vehicle seat 20, while the seat body 100 and the child together are subjected to an inertial force F along the traveling direction R, causing the seat body 100 to pivot forward relative to the base 200 about the pivot axis I along the traveling direction R. The child can thus change from the semi-reclined posture shown in FIG. 1 to a relatively upright posture, which will be described in detail in FIG. 2.

According to the present disclosure, the child safety seat 10 is configured as a buffered child safety seat 10 with a buffering function. The child safety seat 10 has a buffer structure 300. The buffer structure 300 is disposed between the base 200 and the seat body 100 to buffer forward pivotal movement of the seat body 100 relative to the base 200 along the traveling direction R.

According to this embodiment, the buffer structure 300 is configured as a compression spring 300. The seat body 100, particularly at the lower side 112 of the seat portion 110, is provided with an abutment portion 160 for abutting one end of the compression spring 300. The abutment portion 160 may also be fixedly connected to the compression spring 300. The other end of the compression spring is fixed to a fixation portion 260, which is provided on the base body 210 of the base 200, for example, on the upper side 211 of the base body 210. The abutment portion 160 and the fixation portion 260 are merely illustrative in the drawings, and the present disclosure is not limited thereto.

According to the present disclosure, the child safety seat 10 includes a position locking structure 400A. The position locking structure 400A is disposed between the seat body 100 and the base 200 to lock the seat body 100 at various angles relative to the base 200, that is, to lock the seat body 100 at various reclining angles relative to the base 200. The position locking structure 400A may be integrally formed with either the seat body 100 or the base 200; or independently formed and connected to the seat body 100 and the base 200, respectively.

According to this embodiment, the position locking structure 400A is disposed between the base body 210 of the base 200 and the seat portion 110 of the seat body 100. The position locking structure 400A includes a positioning portion 410A fixed to the upper side 211 of the base body 210, and a locking portion 420A fixed to the lower side 112 of the seat portion 110 and movable relative to the positioning portion 410A within the positioning portion 410A. According to this embodiment, the positioning portion 410A is configured to: in the normal use state, adjustably lock the angle of the seat body 100 by positioning the locking portion 420A; and in the collision state, release the locking portion 420A to allow the seat body 100 to pivot, so that an angle of the seat body 100 in the collision state is greater than an angle of the seat body 100 before the collision state, thereby achieving a relatively upright pivotal angle of the seat body 100 relative to the base 200 (see FIG. 2).

According to an embodiment, the abutment portion 160 may be formed with the locking portion 420A integrally, separately, or in combination. According to the present disclosure, the abutment portion 160 may be fixedly provided on the seat portion 110, or the locking portion 420A may be fixedly provided on the seat portion 110, or both the abutment portion 160 and the locking portion 420A may be fixedly provided on the seat portion 110. Additionally, the abutment portion 160 or the locking portion 420A may also be directly formed by the seat portion 110, for example, by molding the abutment portion 160 and/or the locking portion 420A from the seat portion 110.

According to this embodiment, the positioning portion 410A and the locking portion 420A may be configured as corresponding wave portions, tooth portions, or snap portions, etc., for being releasably engaged with each other. The present disclosure is not limited thereto.

When a collision occurs, the positioning portion 410A and the locking portion 420A are disengaged due to the inertial force F. That is, the seat body 100 pivots forward relative to the base 200 along the traveling direction R due to the inertial force F of the seat body 100 and the child together. Thus, the locking portion 420A, fixed to the seat portion 110 of the seat body 100, overcomes the locking force applied by the positioning portion 410A to the locking portion 420A and disengages from the positioning portion 410A along the traveling direction R. In this case, the abutment portion 160, connected to or separated from the locking portion 420A, cooperates with the fixation portion 260 on the base 200 to apply pressure to the compression spring 300. Thus, the compression spring 300 buffers the forward pivoting of the seat body 100, thereby preventing the child from being injured or frightened by a rapid pivoting.

According to the present disclosure, the compression spring 300 may be fixed at only one end or at both ends. Particularly when fixed at both ends, the effect of the compression spring 300, such as elastic force and elastic modulus, needs to be considered during the disengagement of the locking portion 420A from the positioning portion 410A. In this case, the compression spring 300 may provide a buffering effect as early as possible. The compression spring 300 may also provide a buffering effect only after the locking portion 420A has disengaged from the positioning portion 410A, which can advantageously allow the locking portion 420A to disengage quickly from the positioning portion 410A.

According to one embodiment, the compression spring 300 may also not be fixed at both ends but only radially limited. For example, limiting posts (not shown) may be provided on the seat body 100 and the base 200, respectively; and the two ends of the compression spring 300 may be sleeved outside the limiting posts, so that the compression spring 300 is advantageously not squeezed out during compression.

According to the present disclosure, the buffer structure 300 may also be integrally formed with the position locking structure 400A. For example, the positioning portion 410A of the position locking structure 400A may have buffering properties. For example, the positioning portion 410A may be made of rubber, synthetic materials, or other flexible materials. During the disengagement of the locking portion 420A from the positioning portion 410A, the rubber may provide a certain buffering force, such as friction, thereby buffering the pivoting of the seat body 100. In this case, the independent buffer structure 300, such as the compression spring 300, may be omitted, advantageously saving costs.

FIG. 2 is a side view of the child safety seat 10 according to the first embodiment of the present disclosure in a collision state. In this case, the vehicle seat 20 together with the base 200 of the child safety seat 10 fixed thereto suddenly decelerates as the vehicle speed decreases. Since the seat body 100 of the child safety seat 10 is pivotally connected to the base 200 above the seating gravity point 170, the seat body 100 maintains a higher speed along the traveling direction R due to the inertial force F and may achieve a certain acceleration relative to the base 200, causing the seat body 100 to pivot relative to the base 200 about the pivot axis I. The seating gravity point 170 thus moves forward along the traveling direction R from the position shown in FIG. 1. As a result, the backrest 120 of the seat body 10 becomes relatively upright along the vertical direction V, and a distance L2 between the frontmost part of the child's head and the pivot axis I is shorter than the distance L1 therebetween in the normal use state shown in FIG. 1. Therefore, the child's back and head may be better supported by the backrest 120 and the headrest 130, improving the pressure and shaking on the head and neck.

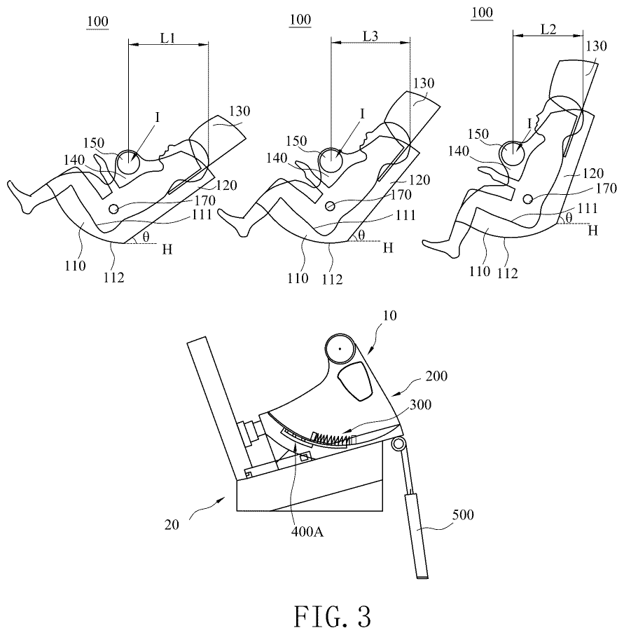

FIG. 3 is an exploded side view of the child safety seat 10 according to the first embodiment of the present disclosure. A lower part of FIG. 3 shows the vehicle seat 20 and the base 200 of the child safety seat 10 fixed thereto. An upper part of FIG. 3 shows, from left to right, the seat body 100 of the child safety seat 10 transitioning from the normal use state to the collision state. In the normal use state, for example, an angle θ of the seat body 100 relative to a horizontal plane H may be adjusted to a semi-reclined position, such as 35 degrees (left figure), and fixed at this angle 0. When subjected to a collision, the seating gravity point 170 moves forward along the traveling direction R from left to right in FIG. 3. At this time, the angle θ of the seat body 100 automatically changes first to 50 degrees (middle figure) and then to 70 degrees (right figure), while the spring 300 is compressed to provide buffering, allowing the child to receive better protection and support. In the collision state, the angle θ of the seat body 100 may also automatically change only to 50 degrees (middle figure). In the normal use state, the distance L1 (35 degrees) or the distance L3 (50 degrees) between the frontmost part of the child's head and the pivot axis I is greater than the distance L2 (70 degrees) in the collision state. The above angles θ are only examples, and the present disclosure is not limited thereto. The angle θ may be any angle between 0 and 90 degrees.

According to some embodiments of the present disclosure, in the normal use state of the child safety seat 10, the angle θ of the seat body 100 relative to the horizontal plane H may be adjusted by the child's caregiver as needed, for example, adjusted to a specific angle θ between a first critical angle and a second critical angle for normal use and fixed at this angle θ. For example, the first critical angle for normal use is the most reclined, such as 35 degrees, and a second critical angle for the normal use is more upright, such as 50 degrees. When subjected to a collision, the seating gravity point 170 moves forward along the traveling direction R. At this time, the angle θ of the seat body 100 automatically changes to exceed the second critical angle for the normal use and up to a third critical angle, such as 70 degrees, while the spring 300 is compressed to provide buffering, allowing the child to receive better protection and support. In the normal use state, the distance L1 (35 degrees) or the L3 (50 degrees) between the frontmost part of the child's head and the pivot axis I is greater than the distance L2 (70 degrees) in the collision state. The above angles θ are only examples, and the present disclosure is not limited thereto. The angle θ may be any angle between 0 and 90 degrees.

According to some embodiments of the present disclosure, the compression spring 300 is configured such that the compression spring 300 is compressed only when the angle θ of the seat body 100 relative to the horizontal plane H exceeds the second critical angle for the normal use, to provide buffering to the seat body 100 when the vehicle is subjected to a collision and the seat body 100 continues to pivot forward due to the inertial force F.

For example, the seat body 100 has an abutment portion 160 for abutting one end of the compression spring 300, and the abutment portion 160 is integrally formed with the locking portion 420A. The other end of the compression spring 300 is fixed to a fixation portion 260, which is provided on the base body 210 of the base 200, for example, on the upper side 211 of the base body 210. Between the first critical angle of 35 degrees and the second critical angle of 50 degrees, the abutment portion 160 does not abut against the compression spring 300 until the angle θ of the seat body 100 relative to the horizontal plane H exceeds the second critical angle of 50 degrees for the normal use, at which point the compression spring 300 is abutted by the abutment portion 160 and compressed. That is, between the first critical angle of 35 degrees and the second critical angle of 50 degrees for the normal use, the compression spring 300 is not in the movement path of the locking portion 420A.

According to the present disclosure, a chance of the abutment between the abutment portion 160 and the compression spring 300 may be adjusted as needed and is not limited thereto. For example, the abutment may also occur between 30 degrees and 50 degrees.

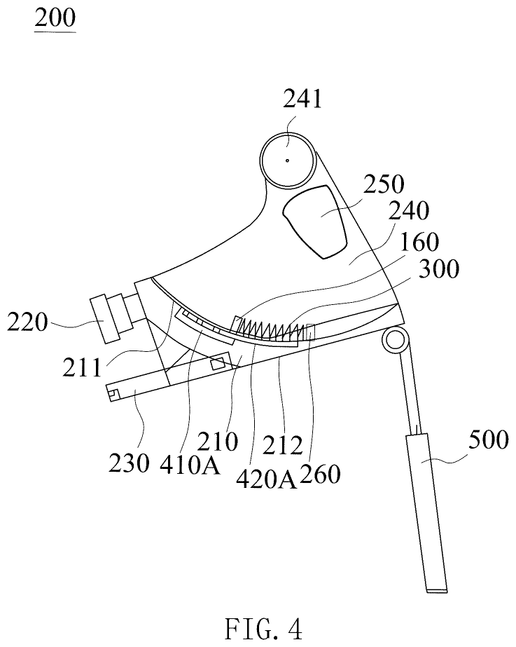

FIG. 4 is a side view of the base 200 of the child safety seat 10 according to the first embodiment of the present disclosure. FIG. 4 independently shows the base 200 to better illustrate a structure of the base 200. The standardized fixation system 230 extends from the base 200, the support member 220 is designed as a telescopic support pad, and the support leg 500 pivots downward from the front side of the lower side 212 of the base body 210 to be supported on the floor of the vehicle (not shown).

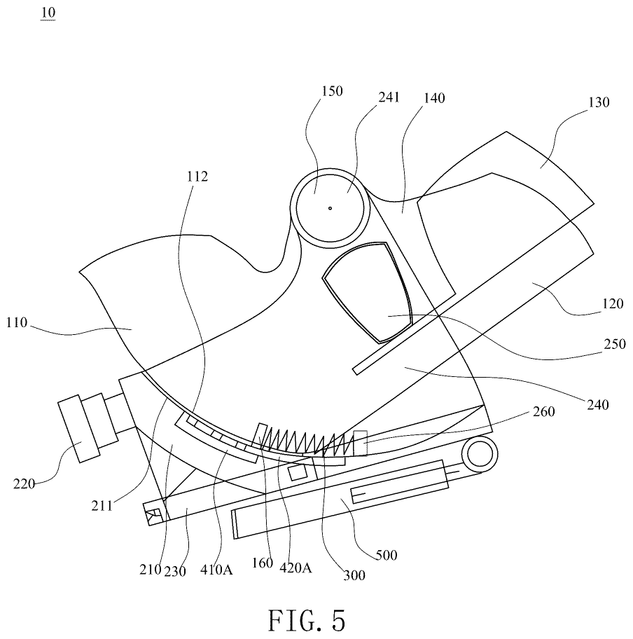

FIG. 5 is a side view of the child safety seat 10 according to the first embodiment of the present disclosure. Unlike FIG. 4, the seat body 100 is combined with the base 200, that is, the pivot portions 150 of the seat body 100 are connected to the pivot connection portions 241 of the base 200 in a coordinated manner to enable the seat body 100 to pivot relative to the base 200. The headrest 130 is mostly retracted into the child safety seat 10 relative to the backrest 120, the support leg 500 is folded close to the base body 210, and the standardized fixation system 230 is also retracted into the child safety seat 10. In this case, the child safety seat 10 is, for example, removed from the car and is in a combined, transportable state.

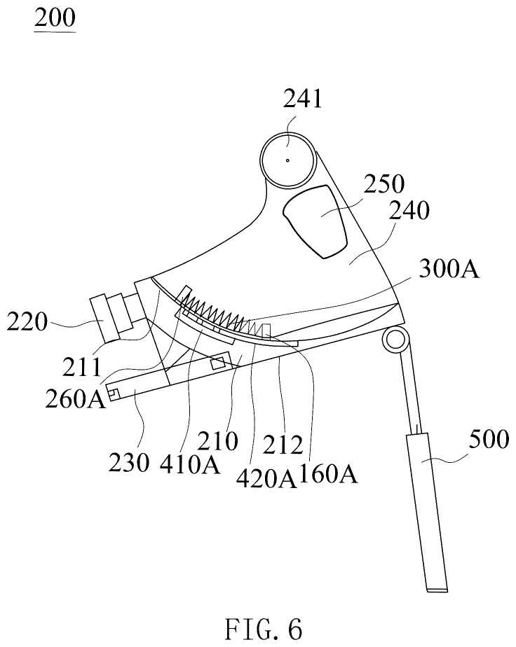

FIG. 6 is a side view of a buffer structure 300A according to another embodiment of the present disclosure. According to this embodiment, one end of the buffer structure 300A, such as a tension spring 300A, is fixed to the seat body 100, and the other end thereof is fixed to the base 200. For example, in the collision state, a pulling portion 160A for pulling one end of the tension spring 300A forward is located on the seat body 100, for example, on the locking portion 420A fixed to the seat body 100 as shown in the figure. The other end of the tension spring 300A is fixed to a fixation portion 260A on the base 200. Thus, when the seat body 100 is subjected to an impact force, the seat body 100 pivots to stretch the tension spring 300A, and the tightening force of the tension spring 300A forms a reaction force to buffer the impact force.

According to the present disclosure, the compression spring 300 and the tension spring 300A may also be leaf springs, elastic plastic strips, etc. The specific implementations of the compression spring 300 and the tension spring 300A may be modified, converted, etc., with reference to each other, without departing from the scope of the present disclosure.

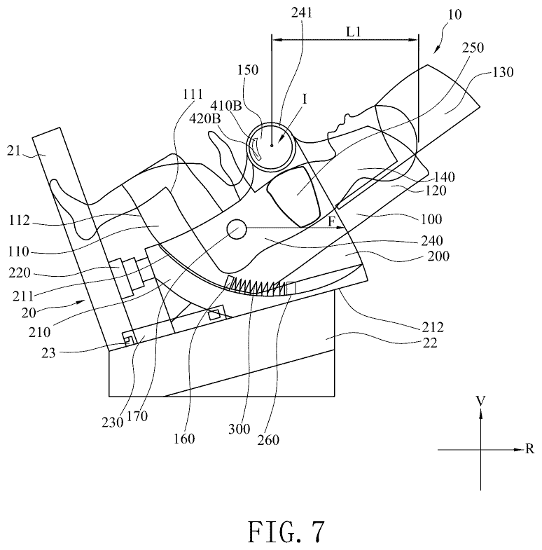

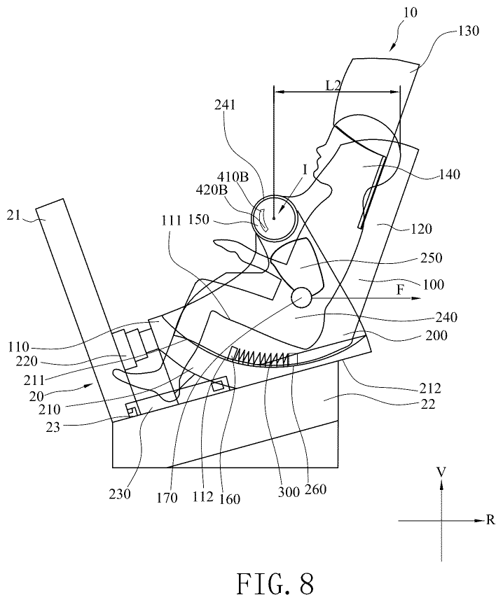

FIGS. 7 and 8 are side views of the child safety seat 10 according to a second embodiment of the present disclosure. To avoid repetition, components identical to those in FIGS. 1 and 2 will not described in detail.

FIG. 7 is a side view of the child safety seat 10 according to the second embodiment of the present disclosure in the normal use state. Illustratively, FIG. 7 is a position locking structure 400B disposed between a pivot connection portion 214 of the base 200 and a pivot portion 150 of the seat body 100. The position locking structure 400B includes a positioning portion 410B located on the pivot connection portion 214, and a locking portion 420B located on the pivot portion 150 and movable relative to the positioning portion 410A within the positioning portion 410A. The positioning portion 410B is configured to: in the normal use state, adjustably lock the angle of the seat body 100 by positioning the locking portion 420B; and in the collision state, release the locking portion 420B to allow the seat body 100 to pivot, so that the angle of the seat body 100 in the collision state is greater than the angle of the seat body 100 before the collision state, thereby achieving a relatively upright pivotal angle of the seat body 100 (see FIG. 8).

According to this embodiment, the positioning portion 410B and the locking portion 420B may be configured as corresponding wave portions, tooth portions, or snap portions, etc., for being engaged with each other, and the present disclosure is not limited thereto. The positioning portion 410B and the locking portion 420B may be provided at the periphery or on opposite sides of the pivot connection portion 241 and the pivot portion 150.

FIG. 8 is a side view of the child safety seat 10 according to the second embodiment of the present disclosure in a collision or emergency braking state. According to the second embodiment, the support leg 500 of the first embodiment may also be omitted, and only the buffer structure 400B and the seat rotation structure according to the present disclosure may be used. In this way, during a collision, the child safety seat 10 rotates in the opposite direction to improve head displacement, thereby eliminating the need for a load leg, top tethers, or low tethers. This can simplify the use for consumers and allow the protection of the child to be achieved using only the standardized fixation system, ISOFIX.

Since the present disclosure may be implemented in various forms without departing from the spirit and essence of the disclosure, it should be understood that the aforementioned embodiments are not limited to any of the foregoing details. Instead, they should be interpreted in a broadest sense within the scope defined by the claims. Therefore, all changes falling within the scope of the claims or their equivalents shall be covered by the claims.

What is claimed is:

1. A child safety seat, for being fixed to a vehicle seat, comprising:
a base for being fixed to the vehicle seat;
a seat body for seating a child and pivotally connected to the base about a pivot axis, wherein a seating gravity point of the seat body together with the child is located below the pivot axis when the child is seated in the seat body; and
a buffer structure disposed between the base and the seat body, for buffering a pivotal movement of the seat body relative to the base.

2. The child safety seat according to claim 1, wherein:
the child safety seat comprises a position locking structure disposed between the seat body and the base, for locking the seat body at various angles relative to the base.

3. The child safety seat according to claim 2, wherein:
the base comprises a base body for being fixed to the vehicle seat and side portions extending upward from both sides of the base body, wherein pivot connection portions are respectively provided on the side portions, and
the seat body is disposed in a receiving space formed between the base body and the side portions, the seat body having a pivot portion cooperating with the pivot connection portions, wherein centers of the pivot connection portions and the pivot portion form the pivot axis to enable the pivotal movement of the seat body relative to the base.

4. The child safety seat according to claim 3, wherein:
the seat body has side wings for lateral protection of the child, and the pivot portion is provided on the side wings.

5. The child safety seat according to claim 3, wherein:
the position locking structure is disposed between the base body of the base and a seat portion of the seat body, the position locking structure comprising:
a positioning portion located on the base body;
a locking portion located on the seat portion and movable relative to the positioning portion, wherein
the positioning portion is configured to: in a normal use state, adjustably lock an angle of the seat body by positioning the locking portion; and in a collision state, release the locking portion to allow the seat body to pivot, such that an angle of the seat body in the collision state is greater than an angle of the seat body before the collision state.

6. The child safety seat according to claim 5, wherein:
the buffer structure is a compression spring, the seat body has an abutment portion for abutting one end of the compression spring, the abutment portion being integrally formed with the locking portion, and the other end of the compression spring is fixed to a fixation portion provided on the base.

7. The child safety seat according to claim 5, wherein:
the buffer structure is a tension spring, the seat body has a pulling portion for pulling one end of the tension spring, the pulling portion being integrally formed with the locking portion, and the other end of the tension spring is fixed to a fixation portion provided on the base.

8. The child safety seat according to claim 3, wherein:
the position locking structure is disposed between the pivot connection portion of the base and the pivot portion of the seat body, the position locking structure comprising:
a positioning portion located on the pivot connection portion;
a locking portion located on the pivot portion and movable relative to the positioning portion, wherein
the positioning portion is configured to: in a normal use state, adjustably lock an angle of the seat body by positioning the locking portion; and in a collision state, release the locking portion to allow the seat body to pivot, such that an angle of the seat body in the collision state is greater than an angle of the seat body before the collision state.

9. The child safety seat according to claim 5, wherein:
the positioning portion and the locking portion are configured as corresponding wave portions, tooth portions, or snap portions for engaging with each other, wherein in the event of a collision, the positioning portion and the locking portion are disengaged.

10. The child safety seat according to claim 8, wherein:
the positioning portion and the locking portion are configured as corresponding wave portions, tooth portions, or snap portions for engaging with each other, wherein in the event of a collision, the positioning portion and the locking portion are disengaged.
